(19) United States
(12) Patent Application Publication
(10) Pub. No.: US 2025/0252024 A1
(43) Pub. Date: Aug. 7, 2025

(54) INTEGRATED FAULT INJECTION EMULATORS FOR TESTING INTEGRATED CIRCUIT COUNTERMEASURES

(71) Applicant: NUVOTON TECHNOLOGY CORPORATION, Hsinchu Science Park (TW)

(72) Inventors: Ilan MARGALIT, Tel-Aviv (IL); Ziv HERSHMAN, Givat Shmuel (IL); On MAGEN, Yaaf (IL)

(73) Assignee: NUVOTON TECHNOLOGY CORPORATION, Hsinchu Science Park (TW)

(21) Appl. No.: 18/432,789

(22) Filed: Feb. 5, 2024

(51) Int. Cl. G06F 11/26; G06F 11/00; G06F 11/07; G06F 11/263

(52) U.S. Cl. CPC G06F 11/261; G06F 11/008; G06F 11/079; G06F 11/263

(57) ABSTRACT

An integrated circuit formed with interconnected electronic elements includes at least:
i) functional elements which perform IC operations;
ii) at least one countermeasure (CM) for detecting fault injection attacks upon the IC and outputting an alert signal when a FI attack is detected; and
iii) at least one attack emulator which emulates FI attacks on the IC by applying stimuli to the plurality of functional elements in accordance with at least one control signal.

The IC may include other elements such as power supply elements, oscillators, interface elements and so forth.

### TECHNICAL FIELD

The present disclosure, in some embodiments, thereof, relates to countermeasures for fault injection attacks on integrated circuits, and, more particularly, but not exclusively, to testing and characterization of countermeasures for fault injection attacks on integrated circuits.

### BACKGROUND

Fault injection (FI) attacks on integrated circuits (ICs) are a type of attack that involves injecting or inducing errors into ICs intended to disrupt their normal operation. There are many techniques that may be used to cause faults in integrated circuits, such as through laser irradiation, electromagnetic interference, voltage glitches and others.

ASIC houses which develop chips requiring protection against FI attacks often make use of hardware countermeasures (CMs) within the chip in order to protect it against various types of FI attacks. The CM is intended to detect when a FI attack occurs, so that appropriate actions may be taken in response. Various countermeasures capable of detecting different types of FI attacks such as clock/voltage glitching, data perturbation and others are known in the art.

The ability of a CM to detect a particular attack and its sensitivity to such an attack are extremely important for securing the chip against the attack, while reducing unnecessary disruptions to chip functionality to a minimum. The CM cannot trigger response actions if it does not detect the attack. However, if the CM is overly sensitive it may trigger too many false alarms.

Accurately assessing the effectiveness of CMs in an IC is complex. Current methods use “brute force” testing such as laser or electro-magnetic (EM) radiation to attempt to trigger faults and assess the CMs response under controlled conditions. However, these methods have limited usefulness as replicating more sophisticated attacks is complex, costly and time consuming.

Additional background art includes:

1) J. Breier and X. Hou, “How Practical Are Fault Injection Attacks, Really?,” in IEEE Access, vol. 10, pp. 113122-113130, 2022, doi: 10.1109/ACCESS.2022.3217212. Acknowledgement of the above references herein is not to be inferred as meaning that these are in any way relevant to the patentability of the presently disclosed subject matter.

### SUMMARY OF THE INVENTION

According to some embodiments there is provided an integrated circuit, a method for testing an integrated circuit and a test apparatus for testing an integrated circuit, all of which provide for testing a counter measure's ability to detect a fault injection attack.

The integrated circuit includes at least three types of elements: functional elements which implement the IC's intended functionality, at least one countermeasure element which is designed to output an alert signal when it detects an attack, and at least one attack emulator element. The attack emulator(s) apply stimuli within the IC that “mimic” the effects of an actual FI attack.

The IC is tested by using the attack emulators to emulate one or more fault injection attacks, by applying stimuli which result in similar electrical conditions to the conditions that would be generated when the IC is under a real attack. An analysis of which countermeasures were triggered by the emulated attacks may be used to evaluate the performance (e.g. sensitivity) of the CMs themselves and/or the robustness of the entire IC.

In some cases it may be possible to configure operating parameters of a CM to obtain different sensitivities to attacks. Emulating the same attack with different CM operating parameters may be used to calibrate the CM to parameter settings that are the most effective for detecting the attack.

In one example, a power supply glitch detector CM circuit may be designed with a configurable glitch detection level, which may be configured to detect a glitch when the associated power supply line drops to 20%, or 30% or 40% below the nominal level of the respective supply. An AE may be used to verify that the CM is effective at detecting a real FI attack at a desired level. Consider the case where a CM is set to detect an attack that causes a power supply line drop of 30%. An AE may be used to emulate an attack that is expected to cause a power supply line drop of 30% or within a range such as 30%-35% in order to verify that the CM does detect the attack. Effects of some embodiments of the invention may include but are not limited to:
1) Removes, or at least partially replaces, the need for external means of performing FI attacks to test or characterize the CMs;
2) Attacks with different attack characteristics may be emulated using the same circuitry;
3) Enables automated application of complex combinations and sequences of attacks having different attack characteristics for exhaustive testing and characterization of CM subsystems;
4) Obtains improved countermeasure performance with only a minor increase in die area;
5) Enables testing and characterization of the susceptibility of functional parts in the IC to FI attacks, regardless of countermeasures implemented in the IC.
6) Enables complete characterization of an IC and determination of configuration settings automatically, without human intervention;
7) Enables per-device tuning of CMs, during IC production flow and/or in the field.

According to a first aspect of some embodiments of the present invention there is provided an integrated circuit interconnected electronic elements. The electronic elements comprise:
functional elements configured to perform operations of the integrated circuit (IC);
at least one countermeasure (CM) configured to detect fault injection (FI) attacks upon the IC and to output an alert signal when a FI attack is detected; and
at least one attack emulator associated with the at least one CM, configured to emulate FI attacks on the IC by applying stimuli to the functional elements in accordance with at least one control signal.

According to some embodiments of the invention, the stimuli comprise electrical stimuli.

According to some embodiments of the invention, at least one parameter of the electrical stimulus is controllable by the control signal.

According to some embodiments of the invention, the attack emulator is configured to interfere with an IC clock signal.

According to some embodiments of the invention, the attack emulator is configured to cause abnormal behavior on a power supply line.

According to some embodiments of the invention, the attack emulator is configured to cause abnormal behavior on a ground line.

According to some embodiments of the invention, the attack emulator is configured to change a logic signal in the IC to an opposite logic level.

According to some embodiments of the invention, the attack emulator is configured to cause a shift in the voltage level of a logic signal in the IC towards an opposite logic level.

According to some embodiments of the invention, the stimuli comprise electromagnetic stimuli.

According to some embodiments of the invention, a responsivity of the at least one CM to an attack is adjustable based on results of an emulated attack.

According to some embodiments of the invention, the electronic elements include multiple attack emulators, and wherein at least two of the attack emulators emulate different types of attacks.

According to some embodiments of the invention, at least one of the attack emulators is configured to emulate an attack while the at least one CM are disabled.

According to some embodiments of the invention, the at least one attack emulator is configured to trigger a single CM.

According to some embodiments of the invention, the at least one attack emulator is configured to trigger multiple CMs.

According to some embodiments of the invention, the integrated circuit further includes internal processing circuitry configured to analyze CM response to an emulated FI attack.

According to some embodiments of the invention, the integrated circuit further includes an interface configured to provide the alert signals to an external processor for analysis of a performance of the at least one CM during the emulated FI attack.

According to second aspect of some embodiments of the present invention there is provided a method for testing fault injection countermeasures in an integrated circuit. The method includes:
operating an integrated circuit (IC) comprising multiple interconnected electronic elements. The electronic elements include:
   functional elements configured to perform operations of the integrated circuit (IC);
   at least one countermeasure (CM) configured to detect fault injection (FI) attacks upon the IC; and
   at least one attack emulator associated with the at least one CM, configured to emulate FI attacks on the IC by applying stimuli to the plurality of functional elements; and
during the operating, controlling the at least one attack emulator to emulate an FI attack; and
determining whether the at least one CM detected the emulated FI attack.

According to some embodiments of the invention, the method further includes evaluating an effectiveness of the at least one CM to different FI attacks by controlling the at least one attack emulator to output different stimuli for multiple attack emulations.

According to some embodiments of the invention, the evaluating is based on respective values of at least one characteristic of the attack, the characteristics including at least one of an electrical characteristic of the electronic elements and an electrical distance between an attack emulator applying the stimuli and a CM for detecting the stimuli.

According to some embodiments of the invention, the IC is installed within an operational device and the testing is performed during operation of the device.

According to some embodiments of the invention, emulating the FI attack includes at least one of:
applying an electrical stimulus to the plurality of functional elements;
changing a logic signal in the IC to an opposite logic level;
interfering with an IC clock signal;
abnormal behavior on a power supply line;
abnormal behavior on a ground line; and
applying an electromagnetic stimulus to the plurality of functional elements.

According to some embodiments of the invention, the method further includes using results of an emulated attack to calibrate the at least one CM.

According to some embodiments of the invention, the method further includes evaluating the susceptibility of the IC's functional elements to FI attacks by activating at least one attack emulator to emulate an attack while all of the CMs are disabled and monitoring IC functionality during the emulated attack.

According to a third aspect of some embodiments of the present invention there is provided an apparatus for testing an integrated circuit. The integrated circuit includes multiple interconnected electronic elements. The electronic elements include:
functional elements configured to perform operations of the integrated circuit (IC);
at least one countermeasure (CM) configured to detect fault injection (FI) attacks upon the IC; and
at least one attack emulator associated with the at least one CM, configured to emulate FI attacks on the IC by applying stimuli to the plurality of functional elements in accordance with at least one control signal;
   The apparatus includes:
an interface configured for providing control signals to the at least one attack emulator and for obtaining attack detection signals output by the at least one CM; and
a processing circuitry associated with the interface, configured for generating the control signals to emulate an FI attack, and for analyzing the CM output signals to determine a response of the at least one CM to the emulated attack.

According to some embodiments of the invention, the emulating an FI attack includes at least one of:
applying an electromagnetic stimulus to the plurality of functional elements;
changing a logic signal in the IC to an opposite logic level;
causing a shift in a voltage level of a logic signal in the IC towards an opposite logic level;
interfering with an IC clock signal;
causing abnormal behavior on a power supply line;
causing abnormal behavior on a ground line; and
applying an electromagnetic stimulus to the plurality of functional elements.

According to some embodiments of the invention, the processing circuitry is configured to evaluate a responsiveness of the at least one CM to different emulated FI attacks.

According to some embodiments of the invention, the processing circuitry is configured to output results of the analysis to an external element for redesign of the IC based on the results.

According to fourth aspect of some embodiments of the present invention there is provided a method for testing a susceptibility of an integrated circuit to a fault injection attack, comprising:
operating an integrated circuit (IC) comprising:
   multiple interconnected electronic elements, the electronic elements comprising:
   multiple functional elements configured to perform operations of the integrated circuit (IC); and
   at least one attack emulator, configured to emulate fault injection (FI) attacks on the IC by applying stimuli to the plurality of functional elements; and
during the operating, controlling the at least one attack emulator to emulate an FI attack; and
using a processor, evaluating a functioning of the IC during the emulated attack to determine whether the emulated FI attack disrupts functionality of the IC.

According to some embodiments of the invention, the emulating the FI attack includes at least one of:
applying an electrical stimulus to the plurality of functional elements;
changing a logic signal in the IC to an opposite logic level;
interfering with an IC clock signal;
abnormal behavior on a power supply line;
abnormal behavior on a ground line; and
applying an electromagnetic stimulus to the plurality of functional elements.

According to some embodiments of the invention, the controlling the at least one attack emulator comprises causing the attack emulator to emulate an FI attack detectable by at least one countermeasure circuitry on the IC.

According to some embodiments of the invention, the method further includes using results of the evaluating the functioning of the IC during the emulated attack to calibrate the countermeasure circuitry on the IC.

According to some embodiments of the invention, the method further includes using results of the evaluating the functioning of the IC during the emulated attack to redesign the IC.

According to fifth aspect of some embodiments of the present invention there is provided an apparatus for testing an integrated circuit. The integrated circuit includes multiple interconnected electronic elements. The electronic elements include:
multiple functional elements configured to perform operations of the integrated circuit (IC); and
at least one attack emulator associated with the plurality of functional elements, configured to emulate fault injection (FI) attacks on the IC by applying stimuli to the plurality of functional elements in accordance with at least one control signal;
   The apparatus includes:
an interface configured for providing control signals to the at least one attack emulator and for outputting signals from the IC; and
a processing circuitry associated with the interface, configured for generating the control signals to emulate an FI attack, and for analyzing the output signals from the IC so as to identify an emulated FI attack that disrupts functionality of the IC.

According to some embodiments of the invention, the signals are output from the IC during the emulated attack.

According to some embodiments of the invention, the emulating the FI attack comprises at least one of:
applying an electrical stimulus to the plurality of functional elements;
changing a logic signal in the IC to an opposite logic level;
interfering with an IC clock signal;
abnormal behavior on a power supply line;
abnormal behavior on a ground line; and
applying an electromagnetic stimulus to the plurality of functional elements.

According to some embodiments of the invention, the apparatus further includes internal processing circuitry configured to analyze IC functionality during an emulated FI attack.

Unless otherwise defined, all technical and/or scientific terms used within this document have meaning as commonly understood by one of ordinary skill in the art/s to which the present disclosure pertains. Methods and/or materials similar or equivalent to those described herein can be used in the practice and/or testing of embodiments of the present disclosure, and exemplary methods and/or materials are described below. Regarding exemplary embodiments described below, the materials, methods, and examples are illustrative and are not intended to be necessarily limiting.

Some embodiments of the present disclosure are embodied as a system, method, or computer program product. For example, some embodiments of the present disclosure may take the form of an entirely hardware embodiment, an entirely software embodiment (including firmware, resident software, micro code, etc.) or an embodiment combining software and hardware aspects that may all generally be referred to herein as a “circuit,” “module” and/or “system.”

Implementation of the method and/or system of some embodiments of the present disclosure can involve performing and/or completing selected tasks manually, automatically, or a combination thereof. According to actual instrumentation and/or equipment of some embodiments of the method and/or system of the present disclosure, several selected tasks could be implemented by hardware, by software or by firmware and/or by a combination thereof, e.g., using an operating system.

For example, hardware for performing selected tasks according to some embodiments of the present disclosure could be implemented as a chip or a circuit. As software, selected tasks according to some embodiments of the present disclosure could be implemented as a plurality of software instructions being executed by a computational device e.g., using any suitable operating system.

In some embodiments, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage e.g., for storing instructions and/or data. Optionally, a network connection is provided as well. User interface/s e.g., display/s and/or user input device/s are optionally provided.

Some embodiments of the present disclosure may be described below with reference to flowchart illustrations and/or block diagrams. For example illustrating exemplary methods and/or apparatus (systems) and/or and computer program products according to embodiments of the present disclosure. It will be understood that each step of the flowchart illustrations and/or block of the block diagrams, and/or combinations of steps in the flowchart illustrations and/or blocks in the block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart steps and/or block diagram block or blocks.

These computer program instructions may also be stored in a computer readable medium that can direct a computer (e.g., in a memory, local and/or hosted at the cloud), other programmable data processing apparatus, or other devices to function in a particular manner, such that the instructions stored in the computer readable medium can be used to produce an article of manufacture including instructions which implement the function/act specified in the flowchart and/or block diagram block or blocks.

The computer program instructions may also be run by one or more computational device to cause a series of operational steps to be performed e.g., on the computational device, other programmable apparatus and/or other devices to produce a computer implemented process such that the instructions which execute provide processes for implementing the functions/acts specified in the flowchart and/or block diagram block or blocks.

### BRIEF DESCRIPTION OF THE DRAWINGS

In order to understand the invention, embodiments will now be described, by way of non-limiting example only, with reference to the accompanying drawings. Features shown in the drawings are meant to be illustrative of only some embodiments of the invention, unless otherwise indicated. In the drawings like reference numerals are used to indicate corresponding parts.

In block diagrams and flowcharts, optional elements/components and optional stages may be included within dashed boxes.

In the figures:

FIG. 1 is a simplified schematic illustration of an integrated circuit, according to an exemplary embodiment of the invention;

FIGS. 2-4, which are simplified diagrams of attack emulators for digital signal networks, according to respective exemplary embodiments of the invention;

FIGS. 5-6 are simplified diagrams of attack emulators for power networks, according to respective exemplary embodiments of the invention;

FIG. 7 is a simplified block diagram of a voltage regulator for an attack emulator, according to an exemplary embodiment of the invention;

FIG. 8 is a simplified diagram of an attack emulators for power networks, according to exemplary embodiments of the invention;

FIG. 9 is a simplified flowchart of a method for testing fault injection countermeasures in an integrated circuit, according to embodiments of the invention;

FIG. 10 is a simplified diagram of an apparatus for testing fault injection countermeasures in an integrated circuit, according to embodiments of the invention;

FIG. 11 is a simplified schematic illustration of an integrated circuit, according to an exemplary embodiment of the invention;

FIG. 12 is a simplified flowchart of a method for testing the susceptibility of an integrated circuitry to a fault injection attack, according to embodiments of the invention; and.

FIG. 13 is a simplified diagram of an apparatus for testing fault injection countermeasures in an integrated circuit, according to embodiments of the invention.

The various embodiments of the present invention are described below with reference to the drawings, which are to be considered in all aspects as illustrative only and not restrictive in any manner.

Elements illustrated in the drawings are not necessarily to scale, emphasis instead being placed upon clearly illustrating the principles of the invention. Moreover, two different objects in the same figure may be drawn to different scales.

### DETAILED DESCRIPTION OF EMBODIMENTS

The present disclosure, in some embodiments, thereof, relates to countermeasures for fault injection attacks on integrated circuits, and, more particularly, but not exclusively, to testing countermeasures for fault injection attacks on integrated circuits.

Some embodiments presented herein insert controllable, and optionally configurable, attack emulator elements into an IC which includes countermeasures for detecting fault injection attacks. The attack emulators apply stimuli within the IC which test the countermeasures to determine if a particular stimulus or stimuli cause the countermeasure to detect an attack. Analyzing the results of such tests evaluates the CM performance and/or the IC's robustness against attack. Optionally, the IC, or similar ICs, may be redesigned based on the results in order to increase its overall robustness and/or one or more countermeasures may be calibrated to preferred settings.

Optionally, a similar testing protocol may be performed on a specific IC within an operational device. Thus the countermeasures in a specific IC may be calibrated for their actual working environment and verified therein.

Using on-chip attack emulators provides for easier and more cost-effective testing of the IC design.

The principles, uses and implementations of the teachings herein may be better understood with reference to the accompanying description and figures. Upon perusal of the description and figures present herein, one skilled in the art will be able to implement the teachings herein without undue effort or experimentation.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.
1) Functional elements—Functional elements perform the operations which implement the IC functionality. The functional elements may be any type of IC element, such as logic functions built from logic gates, microprocessors, analog circuitry, memory blocks, and so forth.
2) At least one countermeasure (CM)—A CM detects attacks upon the IC (in particular fault injection attacks) and outputs an alert signal when a FI attack is detected; and
3) At least one attack emulator (AE)—Attack emulator(s) emulate FI attacks on the IC by applying one or more stimuli to the functional elements and/or the associated interconnect or power delivery grid, in accordance with at least one control signal.

The IC may include other elements needed for operation, such as electrical interconnect, power supply elements, oscillators, interface elements and so forth.

As used herein, according to some embodiments of the invention, the term “fault injection attack” means an attack on an integrated circuit which is intended to cause changes in electrical signals (e.g. logic signals and/or voltage signal and/or clock signals) within the integrated circuit.

As used herein, according to some embodiments of the invention, the term “countermeasure” means a circuit within the IC that outputs an alert signal when it detects a fault injection attack.

As used herein, according to some embodiments of the invention, the terms “trigger a countermeasure”, “countermeasure is triggered” and similar terms, mean that a stimulus applied to the IC (by an actual attacker, by a person testing or evaluating the IC, and/or by an attack emulator) causes the countermeasure to output an alert signal.

As used herein, according to some embodiments of the invention, the term “calibrate a countermeasure” means adjusting one or more parameters of the countermeasure that cause it to behave differently in response to the same stimulus from an attack emulator and/or fault injection attack.

As used herein, according to some embodiments of the invention, “effective for detecting an attack” means that an attack with specified characteristics (e.g. above a particular threshold) is detected, without the occurrence of an undesirable number of false alarms (also denoted false positive detections).

As used herein, according to some embodiments of the invention, the term “emulate an attack” means to apply a stimulus within the IC the effective results of which are similar to those expected to be caused by a fault injection attack.

As used herein, according to some embodiments of the invention, the term “attack emulator” (abbreviated AE) means a circuit within the IC that generates a stimulus similar to that expected to be caused by a fault injection attack.

As used herein, according to some embodiments of the invention, the term “stimulus” means a physical effect that is generated by an attack emulator that causes a change in the behavior of a signal and/or power supply within the IC (such as a change in voltage, current, state, timing, etc.).

As used herein, according to some embodiments of the invention, the term “activate an attack emulator” means to cause an attack emulator to generate the stimulus.

As used herein, according to some embodiments of the invention, the term “glitch” means a short-duration pulse of voltage or current.

### Countermeasures

According to some embodiments of the invention, the subject CMs monitor the electrical behavior of signals and/or element behavior and/or networks in a chip (e.g. digital signals, clock signals, power delivery network, etc.). When a CM detects an FI attack it typically outputs an alert signal.

CMs may perform functions such as high fanout network (HFN) monitoring, clock integrity monitoring, power glitch detection, detecting electromagnetic fault injection, etc. For example, U.S. Pat. No. 9,523,736, which is incorporated in its entirety by reference into the specification, describes a CM for detecting fault injection in and/or utilizing a high-fanout network.

Optionally, the alert signal is simply an indicator that an attack was detected. Alternately, the alert signal may include further information, for example relating to the type of attack, detected signal levels, timing and so forth.

The alert signal may be of any type known in the art, such as digital, analog and/or a combination of digital and analog signals.

Optionally, the IC includes multiple CMs. Further optionally, the IC includes at least two types of CMs.

Further optionally, the CMs are used to detect at least two types of FI attacks. Alternately or additionally, multiple CMs detect the same type of attack.

Optionally, at least one CM in the IC is capable of detecting more than one type of FI attack. Thus the robustness of the chip to multiple types of FI attacks may be evaluated using a single CM.

Optionally, when parameters of the CM operation may be set or calibrated after manufacture (e.g. during test and/or operation), the CMs may be experimentally set to operate with different parameter settings during different emulated attacks, in order to determine preferred parameter settings for one, some or all of the CMs. Thus the results of the attack emulation(s) may be used to calibrate the CM(s) in order to tune the CM responsivity to an attack.

Optionally, some or all of the alert signal(s) and/or derivatives of some or all of the alert signal(s) and/or other representations of some or all of the alert signal(s) are output from the IC for external processing (e.g. to evaluate CM performance and/or overall resistance of the IC to the attack). Alternately or additionally, at least some of the processing and evaluation of the alert signals are performed by internal processing circuitry on the IC itself.

### Attack Emulators

According to some embodiments of the invention, an attack emulator applies a stimulus to the IC that is intended to create conditions that are similar to those that would occur when the IC is under an actual FI attack. Examples of attack emulators are presented in more detail below.

The attack emulators may be placed at locations of interest within the IC design to test the effects of stimuli on near and/or far CMs, and/or to test the effects on sensitive circuit elements in its vicinity.

The stimulus applied by the attack emulator may be of any type that may interfere with the operation of the IC.

Note that a stimulus applied by an attack emulator may not necessarily trigger a CM. Non-triggering of a CM in response to a stimulus applied by an attack emulator indicates that the CM did not detect the emulated attack, for example due to the characteristics of the stimulus applied by the attack emulators such as amplitude, duration, frequency, location within a clock cycle, the characteristics of the stimulus relative to the settings of the CM under evaluation, the physical distance between the attack emulator and the CM circuit, and so forth. In some cases this is a desirable result which indicates that the CM is not too sensitive to a particular stimulus (e.g. a low amplitude glitch).

The attack emulator control signal(s) may be any type of signal which causes the attack emulator to apply a stimulus to element(s) in the IC. Examples of control signals may include but are not limited to: digital signals, analog signals, and clock signals.

Optionally, the control signal to the attack emulator is a digital signal.

Optionally, the control signal to the attack emulator is a trigger signal that causes the attack emulator to output a known stimulus (e.g. a particular electrical signal).

Alternately, the control signal(s) to the attack emulator affect parameters of the attack emulator output signal(s), for example the amplitude and/or duration and/or timing of the stimulus. Thus the CM(s) may be tested under different conditions of attack by the same attack emulator.

Optionally, the IC includes a single attack emulator.

In alternate embodiments of the invention, multiple attack emulators are located within the IC circuit. Further optionally, at least two of the attack emulators emulate different types of attacks.

Optionally, attack emulators are located at different distances from the CM(s). This enables checking whether a CM is affected by its proximity to the attack emulator(s).

Optionally, at least one attack emulator is configured to trigger a single CM (e.g. by locating it physically close to the CM).

Alternately or additionally, at least one attack emulator is configured to trigger multiple CMs. As noted above, although an attack emulator may be configured to trigger multiple CMs, one or more of the CMs may not detect an emulated attack.

Determining that a CM was not triggered by an attack emulator may be an important part of testing the resilience of the IC to FI attack. The conditions under which a CM is or is not triggered by the attack emulators may be analyzed to determine if the CM is capable of detecting an attack with particular characteristics and/or to determine whether the CM detects attacks under conditions which are not intended to trigger an alert signal (e.g. to check that small glitches do not trigger the CM).

Optionally, multiple attack emulators are activated together (possibly in different constellations). This emulates a multiple-attack scenario and enables checking the response of the CM(s) to stimuli from multiple sources.

In some embodiments of the invention, the stimulus applied by an attack emulator is electrical (i.e. may be expressed in terms of a voltage level and/or current level). In alternate or additional embodiments of the invention, the stimulus applied by an attack emulator is non-electrical.

Optionally, the attack emulator applies an electrical stimulus that causes abnormal behavior on a power supply line.

Optionally, the attack emulator applies an electrical stimulus that causes abnormal behavior on a ground line.

Optionally, the attack emulator applies an electrical stimulus that changes a logic signal in the IC to an opposite logic level.

Optionally, the attack emulator applies an electrical stimulus that causes a shift in the voltage level of a logic signal in the IC towards an opposite logic level.

Optionally, the attack emulator applies an electrical stimulus that interferes with an IC clock signal. Examples of interfering with an IC clock signal include but are not limited to:
i) Distorting or glitching the clock signal to selectively skip clock signal pulses; and
ii) Introducing extraneous high and/or low clock pulses.

In some embodiments of the invention, the stimulus applied by the attack emulator is electromagnetic. Optionally, the attack emulator includes a radiating element that emits an electromagnetic signal utilizing techniques such as deliberate crosstalk or others to create such an effect.

Optionally, the stimulus duration is very short, causing a glitch within the IC (for example a fraction of a clock period duration). In one example, the logic level at a particular location on the IC switches momentarily to the opposite logic level. In a second example, the stimulus is a brief power spike on a power line. In a third example, the stimulus is a brief short circuit of a signal line or a power line to ground.

Optionally, at least one of the attack emulators is configured to emulate an attack while the CM(s) are disabled. This enables evaluation of the IC's susceptibility to a particular attack or attacks without alerts from CM(s). Alternately or additionally, some or all of the CM(s) are not disabled, but the alert signals provided (or not provided) the CM(s) is ignored for the evaluation.

### Interface and Processing

Optionally, the IC includes an interface which serves for inputting the attack emulator control signals to the IC.

Alternately or additionally, the interface serves for providing the CM alert signal(s) to an external processor and/or controller.

Alternately or additionally, the IC includes internal processing circuitry 160. Examples of tasks that may be performed by internal processing circuitry include but are not limited to: providing control signals, reading CM output signals, and calibrating CMs.

Optionally, the internal processing circuitry includes a processor executing software instructions. Further optionally, the software instructions control, at least in part, attack emulator settings and/or activation.

Optionally, the internal processing circuitry includes volatile and/or non-volatile memory.

Optionally, the internal memory stores software instructions for execution by a processor.

Alternately or additionally, the internal memory stores data which may be used for embodiments of the invention. Examples of additional data which may be stored in the memory, according to some embodiments of the invention, include but are not limited to specifications for emulated attacks, CM characteristics and parameter settings, test result data, data collected during operation of the IC, etc. In some embodiments of the invention, at least some data stored in the internal memory is used for analysis and evaluation of the IC performance, particularly during emulated FI attacks.

In some embodiments of the invention, the CM output signals are analyzed to evaluate the CM performance during emulated FI attack(s). The analysis may be performed by external and/or internal processors.

Optionally, parameters of at least one CM are adjusted based on the evaluation.

Optionally, parameters of the emulated attack are adjusted based on the evaluation, in order to test CM responses to different attack scenarios.

Optionally, the IC and/or a different IC integrating the same or similar CM circuitry is redesigned based on the analysis of the CM response to emulated attacks.

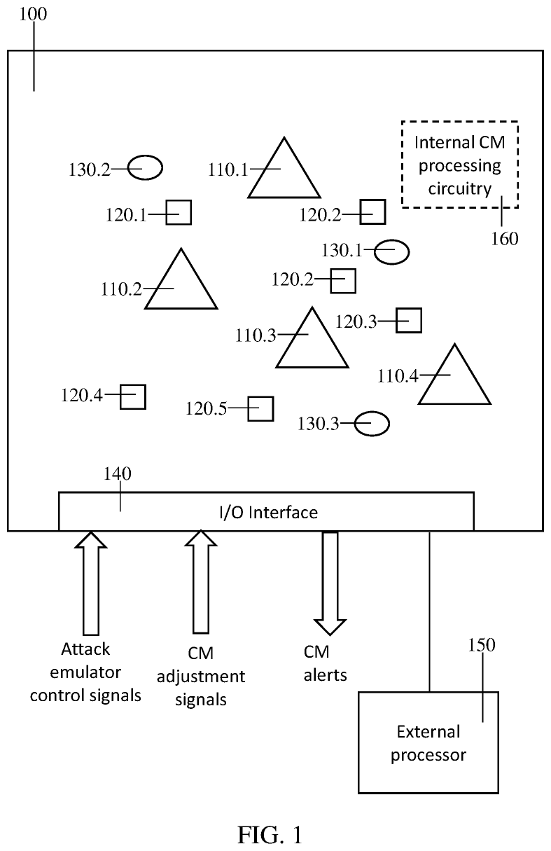

Reference is now made to FIG. 1, which is a simplified schematic illustration of an integrated circuit, according to an exemplary embodiment of the invention. FIG. 1 is for illustrative purposes only and does not indicate actual circuit elements or interconnections therebetween.

For clarity the functional elements, countermeasures and attack emulators are illustrated in FIG. 1 as separate entities. However ASICs may include tens of millions of logic gates. In practice it is expected that these elements will be dispersed on the IC chip. FIG. 1 is not limiting with regards to the number and/or types and/or interconnections of the functional elements, CM(s), and attack emulator(s).

IC 100 includes: functional elements 110.1-110.4 (illustrated as triangular), CMs 120.1-120.5 (illustrated as square) and attack emulators 130.1-130.3 (illustrated as ovals).

Optionally, IC 100 includes I/O interface 140 for inputting and outputting signals to and from IC 100. In the context of the attack emulation described herein, I/O interface 140 may be used to input control signals for the attack emulators and/or output alerts from the CMs and/or input calibration signals for calibrating the CM responsivity to stimulation. Alternately or additionally, I/O interface 140 may be used for communication with external devices or systems, for example with external processor 150.

The IC may be designed and/or manufactured according to any technology known in the art which enables embedding CMs and attack emulators in the integrated circuit. Such technologies may include but are not limited to any standard CMOS wafer foundry process with any geometry enabling the design and manufacturing of very-large-scale integration (VLSI) IC devices.

### I. Attack Emulators for High Capacitance Networks

Some networks within an IC have relatively high capacitance and are expected to exhibit slow changes in signal levels.

For example, high fanout networks (HFN) are large networks that spread over very large areas of the chip, which are expected to be normally static (i.e. change state very rarely). A CM for a HFN may, for example, verify the coherency of the logic value of the net across various physical locations.

Power networks are also normally static. They may show changes in power level resulting from normal chip activity, but this is expected to be within a limited range of change. Power networks are also very heavy in capacitance (typically much heavier than HFNs) and are driven to their level by very powerful devices (typically low-dropout regulators) in the chip and/or outside the chip. A CM for a power network may be an analog glitch detector.

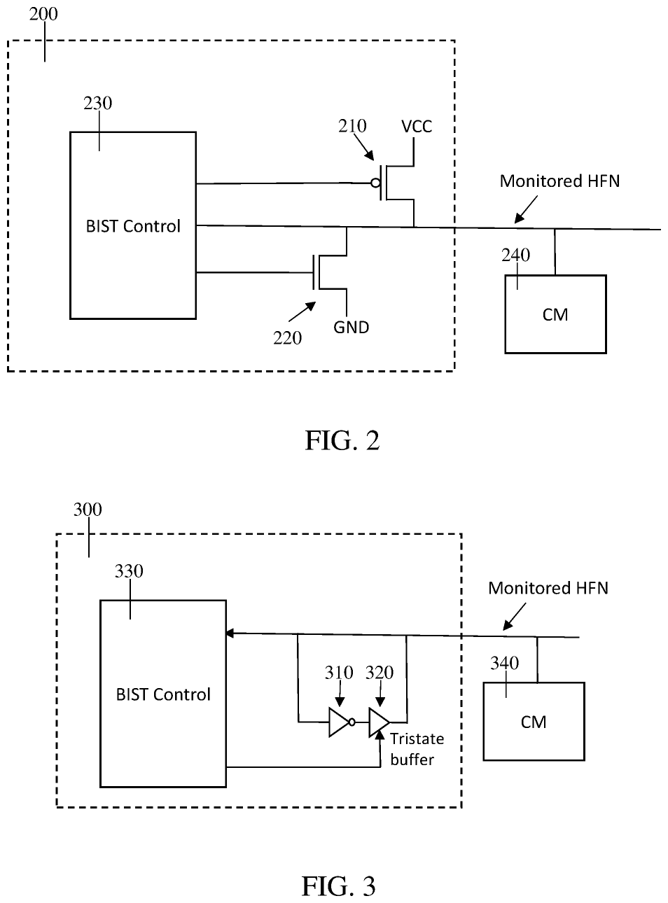

Reference is now made to FIGS. 2-4, which are simplified diagrams of attack emulators for digital signal networks, according to respective exemplary embodiments of the invention. For clarity, some of the description of FIGS. 2-4 is directed at attack emulators for a high frequency network. As will be apparent to the skilled person, the same or similarly structured attack emulators may be used for other types of networks (including relatively static digital signal networks).

FIG. 2 illustrates a first exemplary embodiment of an attack emulator for an HFN. Attack emulator 200 is formed of PMOS transistor 210, NMOS transistor 220, and built-in test (BIST) control 230. FIG. 2 illustrates a simple circuit configuration for creating glitches on an HFN line using two transistors. As will be appreciated by the skilled person, the same electrical behavior may be created using other circuit configurations (some of which are described below). Furthermore, additional electrical elements such as resistors and capacitors may be used to affect electrical characteristics of the glitch, such as the glitch shape.

One terminal of PMOS transistor 210 is tied to VCC and a second terminal is tied to a location in the HFN. One terminal of NMOS transistor 220 is tied to ground (GND) and a second terminal is tied to substantially the same location in the HFN. Countermeasure 240 is also connected to an HFN line in order to detect glitches in the logic levels on the HFN.

The gates of MOS transistors 210 and 220 are connected separately to BIST control 230, which may activate either (or both) of them at any given time by applying control signals to the transistors' gates. For example, applying a brief pulse to the gate of PMOS transistor 210 while NMOS transistor 220 is off will briefly connect the HFN line to VCC. Similarly, applying a brief pulse to the gate of NMOS transistor 220 will briefly connect the HFN line to GND. CM 240 outputs an alert if it detects the glitch as an attack. Both PMOS transistor 210 and NMOS transistor 220 have the electrical capabilities needed to produce the required effect to be applied to the associated HFN.

BIST control 230 may control the transistor gates in any way desired for emulating a particular attack. For example, BIST control 230 may activate the transistors based on externally provided signals (e.g. manual activation) or automatically using internal control logic (e.g. using a sequencing machine).

Optionally, the decision whether to activate PMOS transistor 210 and/or NMOS transistor 220 depends on the current logical state of the HFN.

In an alternate optional embodiment, attack emulator 200 serves to interfere with an IC clock signal, using appropriate control signals from BIST control 230. In one example, BIST control 230 may monitor the clock signal, detect the end of a clock pulse, and then apply an additional clock pulse between that previous clock pulse and the next.

FIG. 3 illustrates a second exemplary embodiment of an attack emulator for an HFN. Attack emulator 300 applies a stimulus based on the current logical state of the protected HFN. BIST control 330 controls controllable tristate buffer 320. When tristate buffer 320 is on, the output of inverter 310 is connected to the HFN line. Thus a stimulus (e.g. glitch) with a logic level opposite to the current level of the HFN is applied. Note that in this embodiment control 330 does not need to know the state of the monitored net in order to apply the opposite logic level. Additionally, when the HFN changes its state the glitch may stop or may create oscillations on the HFN (yielding a slightly different glitch shape).

FIG. 4 illustrates a third exemplary embodiment of an attack emulator for an HFN. Attack emulator 400 has a similar structure to attack emulator 200 (see FIG. 2), but further includes analog voltage control circuitry 450 which enables controlling of the magnitude of the stimulus applied to the HFN to voltages between VHigh and VLow.

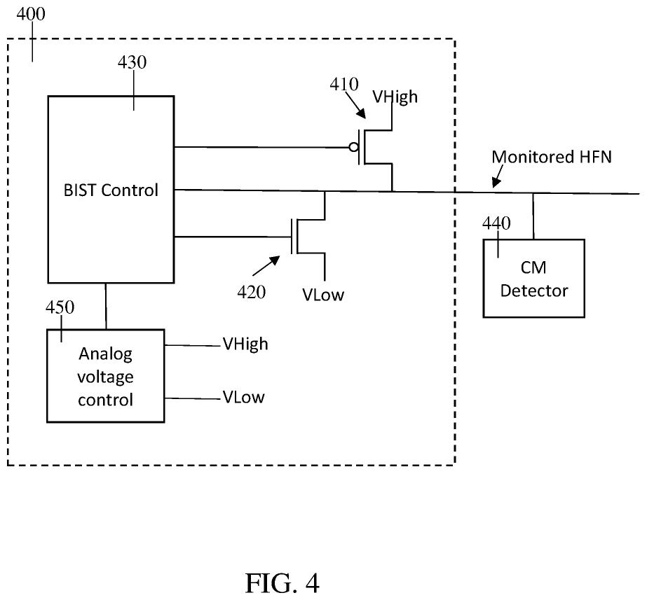

Reference is now made to FIGS. 5-8, which are simplified diagrams of attack emulators for power networks, according to respective exemplary embodiments of the invention.

FIG. 5 illustrates a first exemplary embodiment of an attack emulator for a power network. FIG. 5 achieves highly controllable glitch strength and duration with a similar usage of PMOS and NMOS transistors with terminals connected to VHIGH/VLOW supplies respectively. BIST control 530 controls the gates of PMOS transistor 510 and NMOS transistor 520 and the state of analog switch 560. Analog switch 560 may disconnect supply 550 from CM detector 540 during testing without disturbing the power supply, and gaining a separate low-capacitive monitored node that may be controlled with very high accuracy.

Optionally, attack emulator 500 further includes analog voltage control circuitry 535 which enables controlling of the magnitude of the stimulus applied to the HFN to voltages between VHigh and VLow.

FIG. 6 illustrates an exemplary embodiment of an attack emulator for power networks which reuse embedded chip elements.

FIG. 6 contains embedded voltage regulator (VR) 600 as a main supply and the digital circuit current load (e.g. built-in digital modules, standard cell chains, memories, other supplied circuitry, etc.), which may be reused by the BIST control for glitching purposes. The monitored supply voltage and the digital circuit current load may be controlled by one or more of the following actions:
a) Momentary shutting VR 600 off to avoid contention with the glitch;
b) Controlling VR 600 itself through the voltage reference;
c) Controlling VR 600 itself through oscillations and/or disturbance directly on its pass device gate (VGATE in FIG. 6) to weaken/enforce it; and
d) Controlling DIGITAL LOAD 630, by activating various digital modules in various manners to provide a (typically very large) current load for supply glitching.

Optionally, the stimulus (e.g. glitch) is performed using above-described actions (a-d), alone or in combination. Non-limiting examples include:
a) Massive drive of multiple IOs upon command from the CM-BIST to internally cause a glitch (the number of IOs, and their drive strength, slew rate, the output contention value and so can be configured to control the glitch intensity—for IO supply glitches).
b) Logic circuit—operating some logic in a dedicated BIST mode in which it consume a large amount of power (e.g. more than allowed for proper operation based on the system specification).

Digital load activation may be performed by various methods.

BIST control 610 outputs three control signals: “REF_CONTROL” to voltage reference 620, “REG_CONTROL” to voltage regulator 600, and “LOAD_CONTROL” to digital load 630. Each control signal may be a BUS of any size. Together the control signals provide the required glitch strength and duration for evaluating CM 640.

Optionally, the attack emulator further includes analog voltage control circuitry 615 which enables controlling of the magnitude of the stimulus applied to the HFN to voltages between VHigh and VLow.

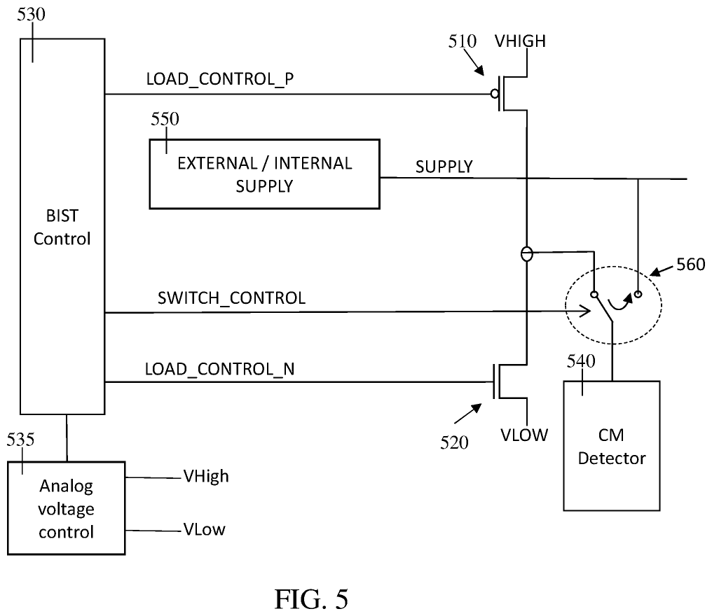

Reference is now made to FIG. 7, which is a simplified block diagram of an exemplary voltage regulator suitable for use in the embodiment of FIG. 6. A regulator control signal (which may be a bus of any size) may turn the VR ON/OFF as described above with respect to FIG. 6. The regulator control signal may also be used to drive the ‘VGATE’ node directly to any required level. VGATE direct control may achieve a rapid OUT response that may serve as a glitch. In addition, the VHIGH voltage may be tuned to a higher or lower voltage level, to achieve up/down glitches and a stronger/weaker VR state.

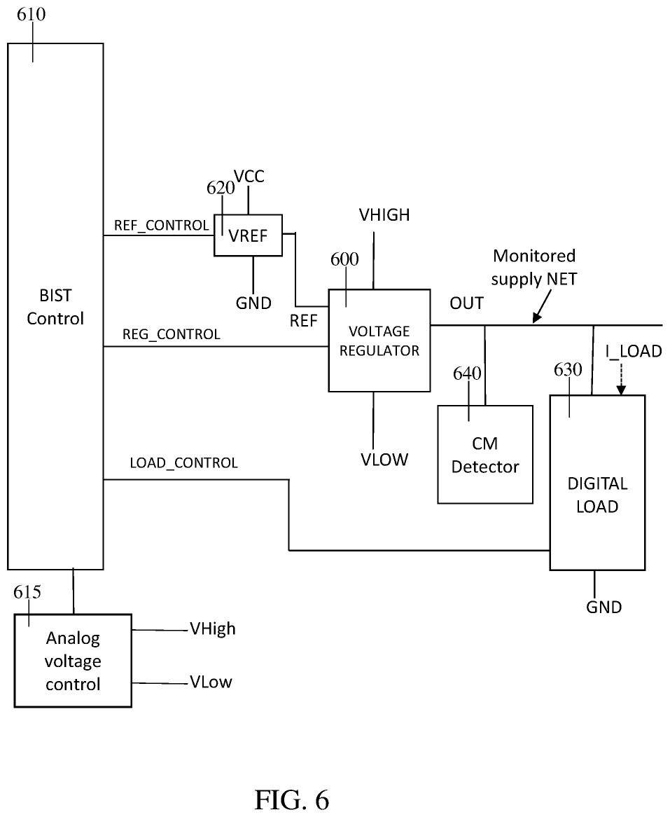

FIG. 8 illustrates an exemplary embodiment of an attack emulator for a power network based on direct access to the supply node. PMOS transistor 810 and NMOS transistor 820 are connected respectively to VHIGH and VLOW supply voltages. In order to apply a stimulus, PMOS transistor 810 and NMOS transistor 820 are turned ON/OFF by BIST control 830, thereby charging or discharging the supply node. The depth of the glitch depends mainly on the PMOS and NMOS (810/820) sizing and the VHIGH and VLOW levels, and the glitch width depends on the control (LOAD control) pulse width.

Optionally, the attack emulator further includes analog voltage control circuitry 835 which enables controlling of the magnitude of the stimulus applied to the HFN to voltages between VHigh and VLow.

Attack emulation by direct control of the supply node may be activated as standalone or may be combined with the reuse embodiments illustrated in FIGS. 6-7.

### II) Attack Emulators for Clock Integrity Monitoring

Clock networks are relatively light in capacitance, and thus toggle quickly and relatively continuously (up to logical gating). CM detector 840 may check for the exact period, and/or exact number of pulses within a time window, and/or for coherency between different branches of clock trees. Accordingly, an attack emulator for a clock network may optionally employ a circuit as depicted in FIG. 2, 3 or 4, so as to apply an extraneous clock pulse onto a clock network and/or mask a valid clock pulse therein.

### Testing Options

Including AEs in an IC enables testing many aspects of the countermeasure performance and the IC itself.
1) Embodiments of the invention may be used for functional tests of the IC by presenting small glitches which should be tolerable by the IC (e.g. not causing a malfunction or an alert) and verifying that the IC withstands these glitches and maintains correct operation. For example:
a. The AEs are coupled with CM detectors, so that the CM detector indications in response to a known tolerable emulated attack are a good indicator for determining whether the CMs are overly sensitive to tolerable attacks.
b. A known-tolerable attack on a chip power network (VCORE) may be emulated by briefly changing the regulator's VREF, which results in a momentary power glitch, and then checking whether the chip shows any malfunction.
2) Distance from of attack emulator from CMs—attack emulators may be placed at locations which are both near and far from the CMs to assess the impact of the physical distance between the location of the emulated attack and the response of a given CM to the emulated attack.
3) Selective activation—different groups of attack emulators may be activated separately to check the response of the IC, for example how the sensitivity of the CMs affects the detection of closer or farther glitches.
4) Glitch depth/strength—An attack emulator may be designed with controllable electrical strength, so that different combinations of strengths and durations of stimuli (e.g. glitches) may be applied to see how the different CMs perform against different stimuli. For example, a net is driven with contention, it needs to ‘fight’ with the natural net driver. Even if the network is driven non-stop it may not reach the target voltage, and even more so if it is driven for a short period of time. Eventually, the drive strength of the net, the voltage of the driving source and the time of the contention drive determine the disturbance/glitch shape (including its width and its peak which are usually somewhat coupled). CM BIST control with drive strength (resistance), drive voltage control and pulse width control may allow granular scanning of the glitch shape space. Note that controlling only some of the parameters may be beneficial. For example, even just controlling the pulse width in fine enough granularity may enable scanning the glitch space to some extent with relatively low cost.
5) The BIST control may be designed to scan over a predefined set of combinations of pulse depth and duration.
6) The testing may be utilized to calibrate process-dependent CMs per given IC. This may be done by defining CM response criteria (e.g. what glitch settings the CM should trigger on) and then calibrating the CM until it responds to the required glitch settings.
7) The AE may apply power and/or signal glitches above their maximum or below their minimum allowed voltage ranges of the respective net. This might be done using available power supplies which are higher than the one of reference, e.g. originating from IO power supplies, or by other means of circuit design. Alternately, this can be done using capacitor charge and discharge or any other kind of charge-pump.
8) The testing may utilize a predesigned mechanism within an on-chip internal power supply (e.g. low-dropout voltage regulator) or its bandgap reference circuit, to create power glitches deliberately at the source of the power. Thus the stimulus is created using the low-dropout (LDO) regulator itself, rather than by a separate circuit directly on the supply line. Thus there is no need to combat the LDO regulator operation in order to create the stimulus. For example, the reference voltage of the voltage regulator may be momentarily modified to cause it to output higher or lower voltage and thereby create the voltage glitch on the supply.
9) Sharing of circuit logic—In some embodiments, an AE output may be electrically connected to more than one physical location on the IC using analog switch(es). Using control logic to control the analog switches, a single AE may emulate an attack at multiple locations on the IC.
10) The timing of the stimulus within the cycle may be controlled by the BIST control, for example the delay relative to the relevant clock edge or by random logic.

### Method for Testing Fault Injection Countermeasures

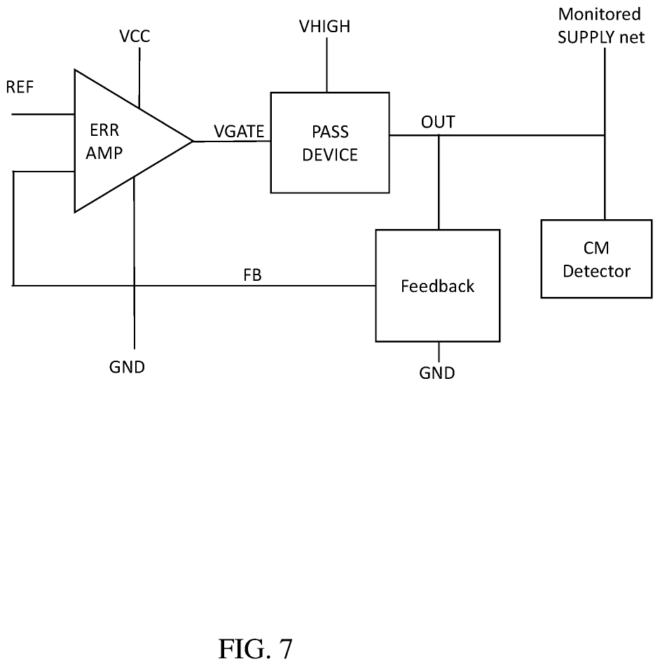

Reference is now made to FIG. 9, which is a simplified flowchart of a method for testing fault injection countermeasures in an integrated circuit, according to embodiments of the invention. The IC includes interconnected, functional elements, at least one CM for detecting FI attacks upon the IC and at least one AE which emulates FI attacks in order to determine whether they are detected by the CM(s).

The IC and the interconnected electronic elements it contains, such as functional elements, CM(s), and attack emulator(s), may be in accordance with any of the embodiments described herein.

In 910 the IC is operated. Operation continues while the CM(s) are being tested.

In 920, at least one attack emulator is configured and controlled to emulate an FI attack.

In 930, a determination is made whether the CM(s) detected the emulated FI attack, for example by determining whether a CM did or did not output an alert signal.

Optionally, the method further includes evaluating the effectiveness of the CM(s) to different FI attacks 940. The attack emulator(s) are controlled to output different stimuli or combinations of stimuli which emulate attacks with different characteristics and the CM output signals resulting from these attacks are analyzed.

Optionally, the evaluation is based on respective values of at least one characteristic of the attack. Characteristics of the attack may include but are not limited to: at least one electrical characteristic of an electronic element (e.g. the effective transistor saturation current) and an electrical distance between an attack emulator applying the stimuli and a CM for detecting the stimuli.

Optionally, the method further includes calibrating the CM(s) 950. Further optionally, the CM(s) are calibrated using the results of one or more emulated attacks, for example by analyzing whether a CM did or did not output an alert signal for a particular attack or group of attacks.

Optionally, an attack emulator emulates an FI attack by performing at least one of:
a) Applying an electrical stimulus to the functional elements;
b) Changing a logic signal in the IC to an opposite logic level;
c) Causing a shift in a voltage level of a logic signal in said IC towards an opposite logic level;
d) Interfering with an IC clock signal;
e) Inducing abnormal behavior on a power supply line;
f) Inducing abnormal behavior on a ground line; and
g) Applying an electromagnetic stimulus to the plurality of functional elements.

Optionally, the method further includes activating at least one attack emulator to emulate an attack while all of the CMs are disabled, and monitoring IC functionality during the emulated attack. Alternately or additionally, some or all of the CM(s) are not disabled, but the alert signals provided (or not provided) the CM(s) is ignored for the evaluation.

Optionally, the IC is installed in an operational device and the testing is performed during operation of the device. This enables calibrating the CMs per device, and possibly per target application system, as opposed to testing the IC independently for design and quality assurance purposes.

### Test Apparatus

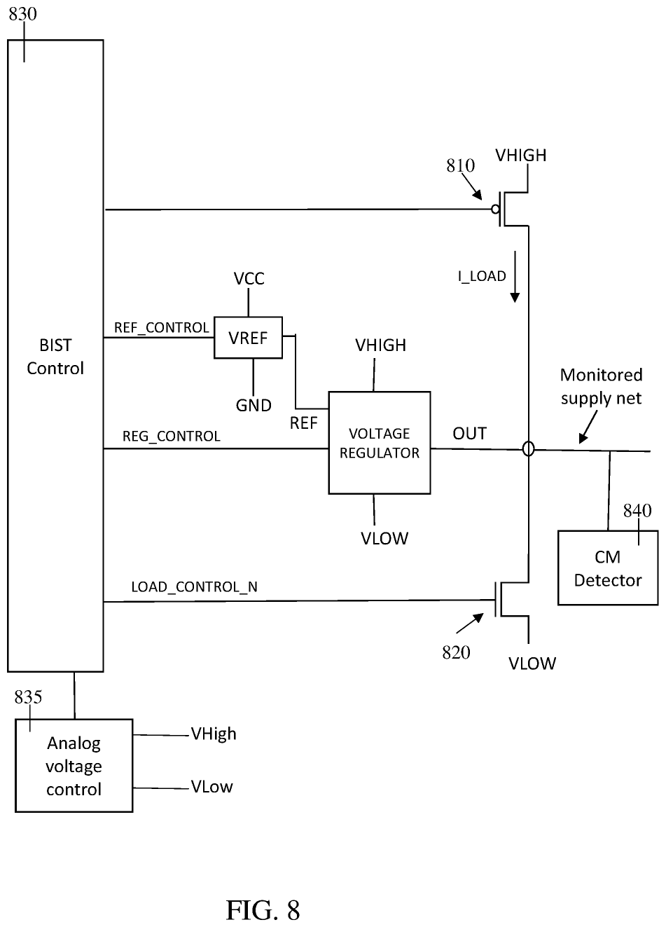

Reference is now made to FIG. 10, which is a simplified diagram of an apparatus for testing fault injection countermeasures in an integrated circuit, according to embodiments of the invention. Test apparatus 1000 performs the method described with respect to FIG. 9, and includes processing circuitry 1010 and interface 1020.

Processing circuitry 1010 may include one or more hardware processors 1030. Optionally, processing circuitry 1010 further includes memory 1040 for storing software instructions to be executed by processor(s) 1030 and/or other information such as specifications for emulated attacks, CM characteristics and parameter settings, test result data, etc.

Interface 1020 provides the control signals to the attack emulator(s) and obtains attack detection signals (i.e. alerts) output by the CM(s).

Processing circuitry 1010 generates the control signals for the attack emulator(s) on IC 1050 and analyzes the CM output signals to determine the response of the CM(s) on IC 1050 to the emulated attack. For example, during a particular emulated attack, some CM(s) may output an alert signal while others do not. CM(s) which output an alert signal may be considered responsive to that attack while the other CM(s) may be considered unresponsive. As noted above, determining that a CM is non-responsive to an attack may be a desired result of the test.

Optionally, processing circuitry 1010 evaluates the responsiveness of the CM(s) to different FI attacks with different characteristics.

Optionally, processing circuitry 1010 outputs results of the analysis to an external element for redesign of IC 1050 and/or CM calibration based on the results.

Optionally, test apparatus 1000 further includes a mount for supporting an IC under test.

### Method of Testing IC Functionality During FI Attack

In some embodiments of the invention, AE(s) may be used to determine how the IC functions during an emulated attack, without using information obtained from a CM.

In some embodiments, the IC performs an action or actions with observable results (e.g. data level and/or signal level) during an emulated FI attack. The observed results are compared to expected results. If they conform to expected results the IC is considered to be functioning properly. If the observed results do not conform to expected results, the IC is considered to be not functioning properly.

Many such tests of IC functionality are known in the art. These test(s) may simply be run while an FI attack is being emulated. It is expected that further tests will be developed in the future, for example to test specific functionality of an IC and/or based on new methodologies and/or for new IC technologies.

For example, a program may be run on the IC to perform calculations and/or cryptographic operation. The results during an emulated attack are stored and checked to determine whether the subject program executes properly (e.g. in the expected order or other aspects of integrity) and/or whether the results of the subject program equal the results of the execution of the same program when it runs undisturbed. The disturbances to the IC may be sophisticated, for example by running multiple levels of attacks, combinations of multiple AEs, etc.

According to some embodiments of the invention, the IC includes at least one of each of the following types of electronic elements:
1) Functional elements—Functional elements perform the operations which implement the IC functionality.
2) At least one attack emulator (AE)—Attack emulator(s) emulate FI attacks on the IC by applying one or more stimuli to the functional elements and/or the associated interconnect or power delivery grid, in accordance with at least one control signal.

Optionally, the IC includes at least one CM which detects attacks upon the IC (in particular fault injection attacks) and outputs an alert signal when a FI attack is detected.

The IC may include other elements needed for operation, such as electrical interconnect, power supply elements, oscillators, interface elements and so forth.

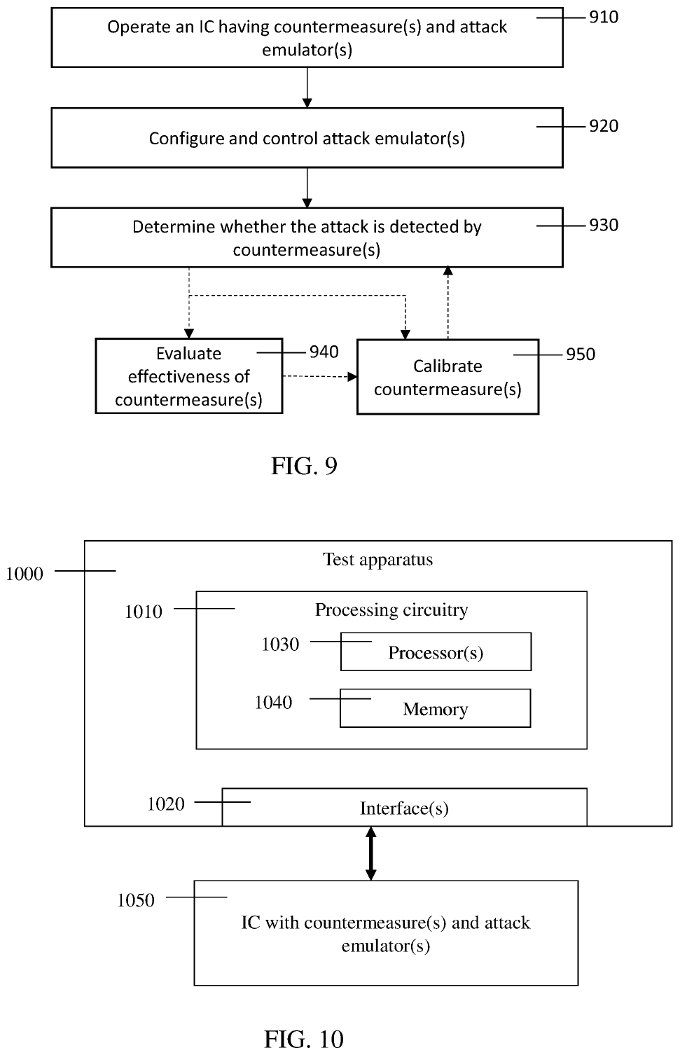

Reference is now made to FIG. 11, which is a simplified schematic illustration of an integrated circuit, according to an exemplary embodiment of the invention. FIG. 11 is for illustrative purposes only and does not indicate actual circuit elements or interconnections therebetween. FIG. 11 is not limiting with regards to the number and/or types and/or interconnections of the functional elements, detection circuitry, and attack emulator(s).

IC 1100 includes:
a) Functional elements 1110.1-1110.4 perform the operations which implement the IC functionality and may be any type of IC element, such as logic functions built from logic gates, microprocessors, analog circuitry, memory blocks, and so forth.
b) Attack emulators 1130.1-1130.3 apply stimuli to emulate an FI attack. Optionally, at least one of AEs 1130.1-1130.3 is in accordance with an exemplary embodiment described above.

Optionally, IC 1110 includes internal processing circuitry 1160 which performs tasks required for IC functionality. Further optionally, internal processing circuitry 1160 performs at least some of the analysis of whether the IC executes correctly during an emulated FI attack.

Optionally, IC 1100 includes I/O interface 1140 for inputting and outputting signals to and from IC 1100. I/O interface 1140 may be used to output information from the IC and/or analysis results from internal processing circuitry 1160 to external processor 1150 and/or to input control signals for the attack emulators.

Optionally, an attack emulator emulates an FI attack by performing at least one of:
a) Applying an electrical stimulus to the functional elements;
b) Changing a logic signal in the IC to an opposite logic level;
c) Causing a shift in a voltage level of a logic signal in said IC towards an opposite logic level;
d) Interfering with an IC clock signal;
e) Inducing abnormal behavior on a power supply line;
f) Inducing abnormal behavior on a ground line; and

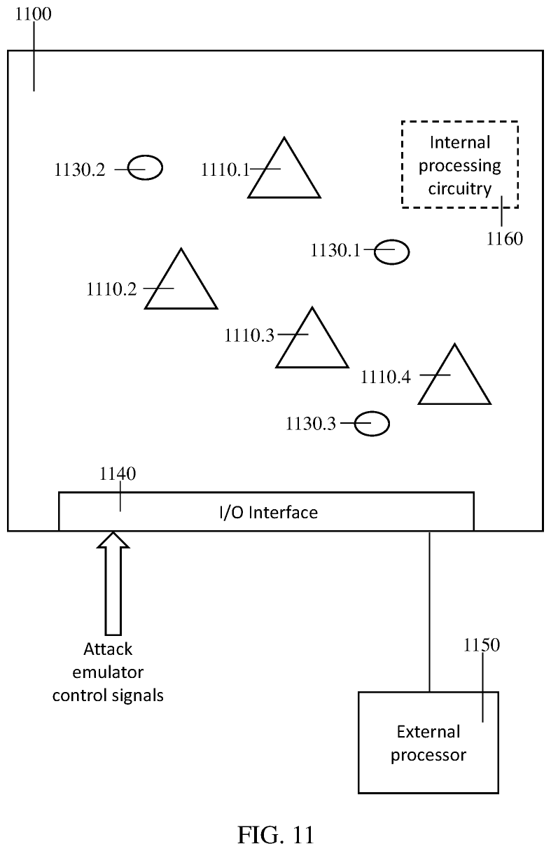

Reference is now made to FIG. 12, which is a simplified flowchart of a method for testing fault injection countermeasures in an integrated circuit, according to embodiments of the invention. The IC includes interconnected, functional elements and at least one AE which emulates FI attacks.

The IC and the interconnected electronic elements it contains, such as functional elements and attack emulator(s), may be in accordance with any of the embodiments described herein.

In 1210 the IC is operated. Operation continues while the IC is being tested. Optionally, during operation the IC executes a known sequence of program instructions.

In 1220, at least one attack emulator is configured and controlled to emulate an FI attack. The attack emulator(s) may be controlled to output different stimuli or combinations of stimuli which emulate attacks with different characteristics.

In 1230, the functioning of the IC during the emulated attack is evaluated to determine whether the IC functionality is disrupted by the emulated FI attack.

Examples of disrupted IC functionality may include but are not limited to: a) Divergence of the execution of an instruction sequence from an orderly flow of execution;
b) Executing an instruction sequence over a different time duration than expected;
c) Executing a forced-bad instruction resulting in the loss of proper flow of execution; and
d) Producing unexpected results.

Optionally, an attack emulator emulates an FI attack by performing at least one of:
a) Applying an electrical stimulus to the functional elements;
b) Changing a logic signal in the IC to an opposite logic level;
c) Causing a shift in a voltage level of a logic signal in said IC towards an opposite logic level;
d) Interfering with an IC clock signal;
e) Inducing abnormal behavior on a power supply line;
f) Inducing abnormal behavior on a ground line; and
g) Applying an electromagnetic stimulus to the plurality of functional elements.

Optionally, the IC is installed in an operational device and the testing is performed during operation of the device. This enables calibrating the IC per device, and possibly per target application system, as opposed to testing the IC independently for design and quality assurance purposes.

Optionally, in 1240 the results of the evaluation are used to calibrate CM circuitry on the IC.

Calibrating the CMs may be based on combined results from the testing of the CMs themselves (e.g. the method of FIG. 9) and on the testing of the IC functionality during emulated FI attack (e.g. the method of FIG. 12). Knowing both the CM response and the IC functionality during emulated FI attacks with known characteristics (e.g. known AE settings), the CM(s) may be calibrated to the most effective setting in which they do not disturb the chip in a safe zone but do raise an alert when an FI attack takes the IC outside its safe zone.

Consider the following numeric example. Testing of a glitch detector CM on an IC found it capable of identifying a glitch as deep as 100, 200, 300 or 400 mV below a minimum power supply of 1.8V. The CM may be set to detect whether power dropped quickly below 1.7V, 1.6V, 1.5V or 1.4V. Additionally, tests of the IC's functionality during emulated FI attacks found that the IC is capable of withstanding glitches (i.e. maintaining functionality) as long as they do not go below 1.5V.

The CM may be calibrated to detect glitches of no less than 200 mV. This accomplishes robust glitch detection with minimal disturbance to the IC (which may occur if the CM is calibrated to detect glitches of 100 mV).

Optionally, in 1250 the results of the evaluation are used to redesign the IC.

### Test Apparatus for Evaluating IC Functionality During an FI Attack

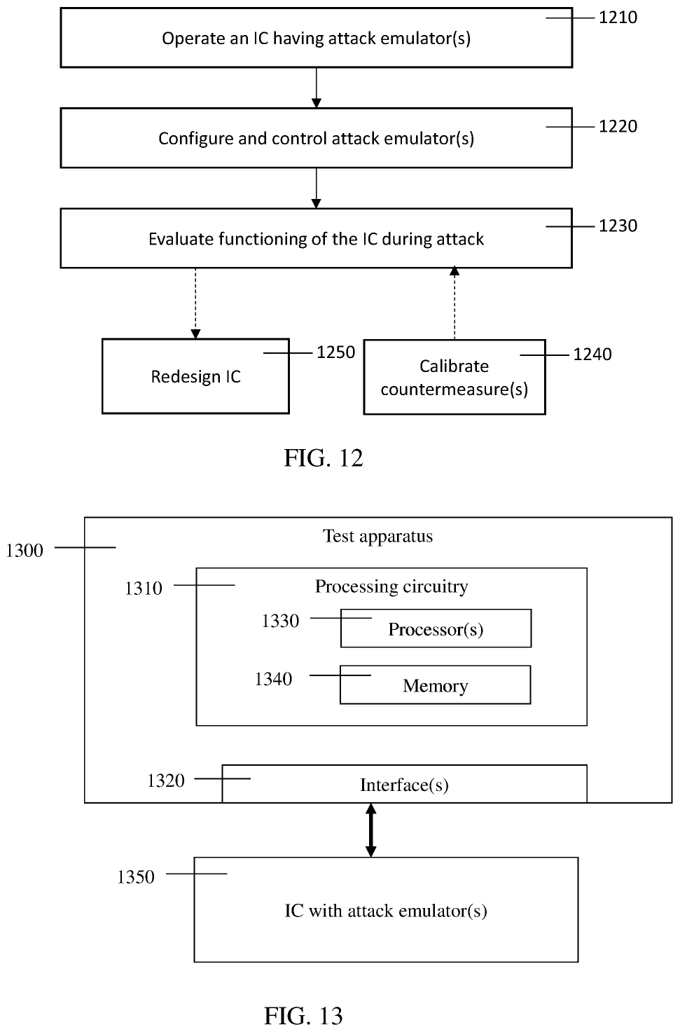

Reference is now made to FIG. 13, which is a simplified diagram of an apparatus for testing IC functionality, according to embodiments of the invention. Test apparatus 1300 performs the method described with respect to FIG. 12, and includes processing circuitry 1310 and interface 1320.

Processing circuitry 1310 may include one or more hardware processors 1330. Optionally, processing circuitry 1310 further includes memory 1340 for storing software instructions to be executed by processor(s) 1330 and/or other information such as specifications for emulated attacks, parameter settings, test result data, etc.

Interface 1320 provides the control signals to the attack emulator(s) and inputs signals from IC 1350.

Processing circuitry 1310 generates the control signals for the attack emulator(s) on IC 1350 and analyzes the signals obtained from IC 1350. The analysis identifies whether an emulated attack has disrupted the IC functionality. The characteristics of the emulated attack are established by the control signals to the attack emulator(s) and may therefore be known or estimated.

Optionally, the signals are output from the IC during said emulated attack. Alternately or additionally, the signals are stored in an internal IC memory and provided to the test apparatus at a later time (e.g. retrieved from the internal memory by the test apparatus prior to the analysis).

Optionally, at least some of the analysis IC functionality during an emulated FI attack is performed by internal processing circuitry on the IC under test.

Optionally, test apparatus 1300 further includes a mount for supporting an IC under test.

### GENERAL

It is expected that during the life of a patent maturing from this application many relevant countermeasures for detecting FI attacks, attack emulators, types of stimuli that emulate an FI attack, tests for evaluating IC functionality and IC technologies will be developed and the scope of the terms countermeasure, attack emulator, stimulus, test of IC functionality and IC are intended to include all such new technologies a priori.

The terms “comprises”, “comprising”, “includes”, “including”, “having” and their conjugates mean “including but not limited to”.

The term “consisting of” means “including and limited to”.

As used herein, singular forms, for example, “a”, “an” and “the” include plural references unless the context clearly dictates otherwise.

Within this application, various quantifications and/or expressions may include use of ranges. Range format should not be construed as an inflexible limitation on the scope of the present disclosure. Accordingly, descriptions including ranges should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within the stated range and/or subrange, for example, 1, 2, 3, 4, 5, and 6. Whenever a numerical range is indicated within this document, it is meant to include any cited numeral (fractional or integral) within the indicated range.

It is appreciated that certain features which are (e.g., for clarity) described in the context of separate embodiments, may also be provided in combination in a single embodiment. Where various features of the present disclosure, which are (e.g., for brevity) described in a context of a single embodiment, may also be provided separately or in any suitable sub-combination or may be suitable for use with any other described embodiment. Features described in the context of various embodiments are not to be considered essential features of those embodiments, unless the embodiment is inoperative without those elements.

Although the present disclosure has been described in conjunction with specific embodiments thereof, it is evident that many alternatives, modifications, and variations will be apparent to those skilled in the art. Accordingly, this application intends to embrace all such alternatives, modifications and variations that fall within the spirit and broad scope of the appended claims.

All references (e.g., publications, patents, patent applications) mentioned in this specification are herein incorporated in their entirety by reference into the specification, e.g., as if each individual publication, patent, or patent application was individually indicated to be incorporated herein by reference. Citation or identification of any reference in this application should not be construed as an admission that such reference is available as prior art to the present disclosure. In addition, any priority document(s) and/or document(s) related to this application (e.g., co-filed) are hereby incorporated herein by reference in its/their entirety.

Where section headings are used in this document, they should not be interpreted as necessarily limiting.

1. An integrated circuit, comprising:
a plurality of interconnected electronic elements, said electronic elements comprising:
a plurality of functional elements configured to perform operations of said integrated circuit (IC);
at least one countermeasure (CM) configured to detect fault injection (FI) attacks upon said IC and to output an alert signal when a FI attack is detected; and
at least one attack emulator associated with said at least one CM, configured to emulate FI attacks on said IC by applying stimuli to said plurality of functional elements in accordance with at least one control signal.

2. The integrated circuit according to claim 1, wherein said stimuli comprise electrical stimuli.

3. The integrated circuit according to claim 2, wherein at least one parameter of said electrical stimulus is controllable by said control signal.

4. The integrated circuit according to claim 1, wherein said attack emulator is configured to interfere with an IC clock signal.

5. The integrated circuit according to claim 1, wherein said attack emulator is configured to cause abnormal behavior on a power supply line.

6. The integrated circuit according to claim 1, wherein said attack emulator is configured to cause abnormal behavior on a ground line.

7. The integrated circuit according to claim 1, wherein said attack emulator is configured to change a logic signal in said IC to an opposite logic level.

8. The integrated circuit according to claim 1, wherein said attack emulator is configured to cause a shift in the voltage level of a logic signal in the IC towards an opposite logic level.

9. The integrated circuit according to claim 1, wherein said stimuli comprise electromagnetic stimuli.

10. The integrated circuit according to claim 1, wherein a responsivity of said at least one CM to an attack is adjustable based on results of an emulated attack.

11. The integrated circuit according to claim 1, wherein said electronic elements comprise a plurality of attack emulators, and wherein at least two of said attack emulators emulate different types of attacks.

12. The integrated circuit according to claim 1, wherein at least one of said attack emulators is configured to emulate an attack while said at least one CM are disabled.

13. The integrated circuit according to claim 1, wherein said at least one attack emulator is configured to trigger a single CM.

14. The integrated circuit according to claim 1, wherein said at least one attack emulator is configured to trigger a plurality of CMs.

15. The integrated circuit according to claim 1, further comprising internal processing circuitry configured to analyze CM response to an emulated FI attack.

16. The integrated circuit according to claim 1, further comprising an interface configured to provide said alert signals to an external processor for analysis of a performance of said at least one CM during said emulated FI attack.

17. Method for testing fault injection countermeasures in an integrated circuit, comprising:
operating an integrated circuit (IC) comprising:
a plurality of interconnected electronic elements, said electronic elements comprising:
a plurality of functional elements configured to perform operations of said integrated circuit (IC);
at least one countermeasure (CM) configured to detect fault injection (FI) attacks upon said IC; and
at least one attack emulator associated with said at least one CM, configured to emulate FI attacks on said IC by applying stimuli to said plurality of functional elements; and
during said operating, controlling said at least one attack emulator to emulate an FI attack; and
determining whether said at least one CM detected said emulated FI attack.

18. The method of claim 17, further comprising evaluating an effectiveness of said at least one CM to different FI attacks by controlling said at least one attack emulator to output different stimuli for a plurality of attack emulations.

19. The method of claim 18, wherein said evaluating is based on respective values of at least one characteristic of said attack, said characteristics including at least one of an electrical characteristic of said electronic elements and an electrical distance between an attack emulator applying said stimuli and a CM for detecting said stimuli.

20. The method of claim 17, wherein said IC is installed within an operational device and said testing is performed during operation of said device.

21. The method of claim 17, wherein said emulating said FI attack comprises at least one of:
applying an electrical stimulus to said plurality of functional elements;
changing a logic signal in said IC to an opposite logic level;
interfering with an IC clock signal;
abnormal behavior on a power supply line;
abnormal behavior on a ground line; and
applying an electromagnetic stimulus to said plurality of functional elements.

22. The method of claim 17, further comprising using results of an emulated attack to calibrate said at least one CM.

23. The method of claim 17, further comprising evaluating the susceptibility of the IC's functional elements to FI attacks by activating at least one attack emulator to emulate an attack while all of said CMs are disabled and monitoring IC functionality during the emulated attack.

24. An apparatus for testing an integrated circuit, wherein said integrated circuit comprises:
a plurality of interconnected electronic elements, said electronic elements comprising:
a plurality of functional elements configured to perform operations of said integrated circuit (IC);
at least one countermeasure (CM) configured to detect fault injection (FI) attacks upon said IC; and
at least one attack emulator associated with said at least one CM, configured to emulate FI attacks on said IC by applying stimuli to said plurality of functional elements in accordance with at least one control signal;
said apparatus comprising:
an interface configured for providing control signals to said at least one attack emulator and for obtaining attack detection signals output by said at least one CM; and
a processing circuitry associated with said interface, configured for generating said control signals to emulate an FI attack, and for analyzing said CM output signals to determine a response of said at least one CM to said emulated attack.

25. The apparatus of claim 24, wherein said emulating an FI attack comprises at least one of:
applying an electromagnetic stimulus to said plurality of functional elements;
changing a logic signal in said IC to an opposite logic level;
causing a shift in a voltage level of a logic signal in said IC towards an opposite logic level;
interfering with an IC clock signal;
causing abnormal behavior on a power supply line;
causing abnormal behavior on a ground line; and
applying an electromagnetic stimulus to said plurality of functional elements.

26. The apparatus of claim 24, wherein said processing circuitry is configured to evaluate a responsiveness of said at least one CM to different emulated FI attacks.

27. The apparatus of claim 24, wherein said processing circuitry is configured to output results of said analysis to an external element for redesign of said IC based on said results.

28. Method for testing a susceptibility of an integrated circuit to a fault injection attack, comprising:
operating an integrated circuit (IC) comprising:
a plurality of interconnected electronic elements, said electronic elements comprising:
a plurality of functional elements configured to perform operations of said integrated circuit (IC); and
at least one attack emulator, configured to emulate fault injection (FI) attacks on said IC by applying stimuli to said plurality of functional elements; and
during said operating, controlling said at least one attack emulator to emulate an FI attack; and
using a processor, evaluating a functioning of said IC during said emulated attack to determine whether said emulated FI attack disrupts functionality of said IC.

29. The method of claim 28, wherein said emulating said FI attack comprises at least one of:
applying an electrical stimulus to said plurality of functional elements;
changing a logic signal in said IC to an opposite logic level;
interfering with an IC clock signal;
abnormal behavior on a power supply line;
abnormal behavior on a ground line; and
applying an electromagnetic stimulus to said plurality of functional elements.

30. The method of claim 28, wherein said controlling said at least one attack emulator comprises causing said attack emulator to emulate an FI attack detectable by at least one countermeasure circuitry on said IC.

31. The method of claim 30, further comprising using results of said evaluating said functioning of said IC during said emulated attack to calibrate said countermeasure circuitry on said IC.

32. The method of claim 28, further comprising using results of said evaluating said functioning of said IC during said emulated attack to redesign said IC.

33. An apparatus for testing an integrated circuit, wherein said integrated circuit comprises:
a plurality of interconnected electronic elements, said electronic elements comprising:
a plurality of functional elements configured to perform operations of said integrated circuit (IC); and
at least one attack emulator associated with said plurality of functional elements, configured to emulate fault injection (FI) attacks on said IC by applying stimuli to said plurality of functional elements in accordance with at least one control signal;
said apparatus comprising:
an interface configured for providing control signals to said at least one attack emulator and for outputting signals from said IC; and
a processing circuitry associated with said interface, configured for generating said control signals to emulate an FI attack, and for analyzing said output signals from said IC so as to identify an emulated FI attack that disrupts functionality of said IC.

34. The apparatus of claim 33, wherein said signals are output from said IC during said emulated attack.

35. The apparatus of claim 33, wherein said emulating said FI attack comprises at least one of:
applying an electrical stimulus to said plurality of functional elements;
changing a logic signal in said IC to an opposite logic level;
interfering with an IC clock signal;
abnormal behavior on a power supply line;
abnormal behavior on a ground line; and
applying an electromagnetic stimulus to said plurality of functional elements.

36. The apparatus of claim 33, further comprising internal processing circuitry configured to analyze IC functionality during an emulated FI attack.
